(19) United States
(12) Patent Application Publication
(10) Pub. No.: US 2016/0086157 A1
(43) Pub. Date: Mar. 24, 2016

(54) PROCESS FOR PAYMENT BY CELL PHONE BY PICTURE AND GPS LOCATION

(71) Applicant: Jaime del Barrio Pison, Algete (ES)

(72) Inventor: Jaime del Barrio Pison, Algete (ES)

(21) Appl. No.: 14/835,752

(22) Filed: Aug. 26, 2015

Related U.S. Application Data
(60) Provisional application No. 62/041,159, filed on Sep. 18, 2014.

(51) Int. Cl. G06Q 20/32; G06Q 20/38

(52) U.S. Cl. CPC G06Q 20/3224; G06Q 20/382

(57) ABSTRACT

The invention these specifications refer to is for a process of a payment system using a cell phone, assisted by a photograph taken and a geo-location system known as “GPS positioning protocol”, all managed by the body which created the “GeoPay online system” (GOS) process, and which validates the data of both user and business and links the banks of both to complete the financial transaction.

Simply and almost instantaneously, a user identified in a business as belonging to this payment system, and to which the business also belongs, is able to complete a secure transaction by matching the image and geo-positioning of both user and business.

### SUBJECT OF THE INVENTION

The invention referred to in these specifications is for a process of a system of payment using a cell phone assisted by a photograph taken of the user and a geo-location system known as “GPS positioning protocol”, all handled by the creator of the “GeoPay online system” (GOS) process that validates the data of both user and business, connecting the banks of each to complete the economic transaction.

Simply and almost instantaneously, a user identified in a business as belonging to this payment system, and to which the business also belongs, is able to complete a secure transaction by matching their image and geo-positioning.

### FIELD OF THE INVENTION

The invention proposed affects the communications industry and the banking industry and, in general, the services industry.

### PRIOR ART

Payment by cell phone is an increasingly pressing demand as part of a secure, cashless market.

This procedure is conceived for all types of economic transactions, irrespective of the amount, so that the speed of the transaction and its security mean it can be used from buying a newspaper or payment of a surface carpark ticket to major purchases of goods and services.

This depends always on the user's financial capacity.

Given its simplicity, security, speed and usability, this process thus enhances everything known until now.

Some patents are known on cell phone payment processes among which the following may be mentioned:

Chinese Patent CN 102376049

Por Cell phone payment confirm based security verification and corresponding method thereof.

In the name of Jinfu HUANG (CN)

In no case is mention made of the two important points of the invention proposed, namely the user's picture and the geo-positioning.

Chinese Patent china CN 202737949

For: Device in a type of inserting card in side face and for expanding cell phone mobile payment application.

In the name of: EASTCOMPEACE TECHNOLOGY CO LTD.

This however is a cell phone payment system with a special card.

In no case is mention made of the two important points of the invention proposed, namely the user's picture and the geo-positioning.

Chinese Patent N 1555179

For: Cell phone payment system

In the name of SHAO UNLI CN

Similarly, no mention is made of the two important points of the invention proposed, namely the user's picture and the geo-positioning.

Perhaps the most similar prior art may be Patent US2014/0201014 referring to a payment procedure using a cell-phone whereby a user interested in paying for his/her purchases in a commercial establishment without the need to physically use a credit card installs in his/her cell phone an mPay application configured to make payments through the cell phone.

The commercial establishment where the paying customer has made his/her purchase, makes it from his/her mPOS application, configured to accept payments from cell phones provided with mPay, a payment request to the mPay/mPOS server, which is the remote sys which allows asynchronous communication between the mobile payment application of the commercial establishment, sends a push message to the customer's cell phone activating therewith the mobile payment application thereof.

The difference between this patent and the proposed invention is important, as it does not include geo-positioning validation to verify the direct link between buyer and seller.

Likewise, immediate and certified identification by the user's image does not form part of this patent.

However, as reference to the current state of the art, it can be pointed out that at least the inventor is unaware of the existence of any other procedure for payment by cell phone combining the two most relevant provisions of the invention, namely the geo-positioning and user verification by facial recognition.

### DESCRIPTION OF THE INVENTION

The invention proposed refers to a process of payment by cell phone with a photograph of the user and GPS positioning of both user and business, based on an application, App called GeoPay which allows an instantaneous payment transaction to be made in any establishment which has this system, very rapidly and securely.

The following are the components involved in such transactions:

A user with a cell phone which has a photographic camera, a user geoKey which authorises a business where payment is possible, a photo of the user, positioning using a GPS positioning protocol, an App called GeoPay app loaded and with the Bank for collection, including the IBAN.

The other component is the business, the place where the product or service is sold, which downloads the “app GeoPay” for which it must provide the following:
A photo of the business,
Geo-positioning of the establishment,
The business Key,
The payment bank, with the IBAN,
A device for receiving the business's data.

A third indispensable component is the Bank, issuer of the “app GeoPay” (5) for users, but which also can issue for businesses and which is the means whereby the amount of the transaction will go from the user's account to that of the business's bank, once the whole operation has been validated.

The control centre is the “GeoPay online system”, henceforth “GOS”, (the electronic centre for the entire GeoPay system) which does not just validate all the transactions between the system's users but also makes contact between the user's bank and the bank account in the business's bank, to complete the financial transaction.

It also detects intrusions, attacks on the system and puts users, the business and banks in contact, to enlarge the payment possibilities to more users and businesses.

The user downloads the “app GeoPay” sent to it by its bank after the pertinent data have been provided.

A business interested in using this new means of payment asks “GeoPay online Sistem” (GOS) or an authorised bank to be allowed to use it.

The procedure operates as follows:

A user admitted to GeoPay must authorise businesses which accept GeoPay in advance, with the user Geokey chosen when admitted.

This process to admit the business can be completed by the user if actually in the business premises or accessing the list of establishments belonging to the “GeoPay” system and, as pointed out, they must authorise that business with their Geokey in order to make payments with their mobile.

Once an establishment has been admitted, a purchase can be made using “GeoPay”.

When wishing to pay, the GeoPay APP must be run on the mobile phone screen where the establishment involved will appear, with the amount of the transaction to be paid, or by choosing from one of the most commonly paid recently in that business (habitual charge).

The GOS system will use the frontal camera to identify whether the person paying is the one previously admitted from that device with “facial recognition”.

“GeoPay Online System” (GOS) receives this user information and checks all the data of both user and establishment.

With these parameters verified, “GOS” will ask the user's bank to authorise payment.

At that point, GOS sends at least two messages:

The first to the user, indicating that the transaction has taken place, and the second to the business (6) advising it that the transaction has been authorised.

With this response, “GOS” informs user and business that the transaction is authorised.

“GOS” at that point also notifies the business that the transaction been authorised, attaching an electronic message with the authorisation, which includes the user's photo and name (optionally).

There may be a third message, to the business's bank, advising it that a sum will arrive from the user's bank at the business's account for this transaction.

This complex operation in fact lasts just a few seconds thanks to the interrelation of the data bases involved and which are supported in powerful cloud-located data-base systems.

This is the simplest operational part but, with this operational base, it is possible to resolve the entire functioning of relations and incidents between the parties, such as products sent back, claim for errors, duplicated payments etc.

### DESCRIPTION OF THE DRAWINGS

For a better understanding of the invention, two pages of plans are attached, showing the following:

FIG. 1.—

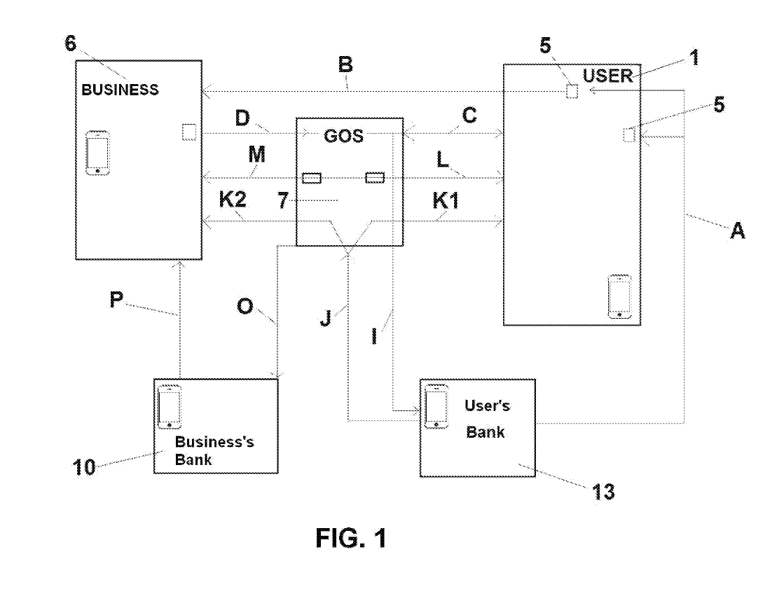

A diagrammatic scheme of the flows referring to the resources of each party involved.

FIG. 2.—

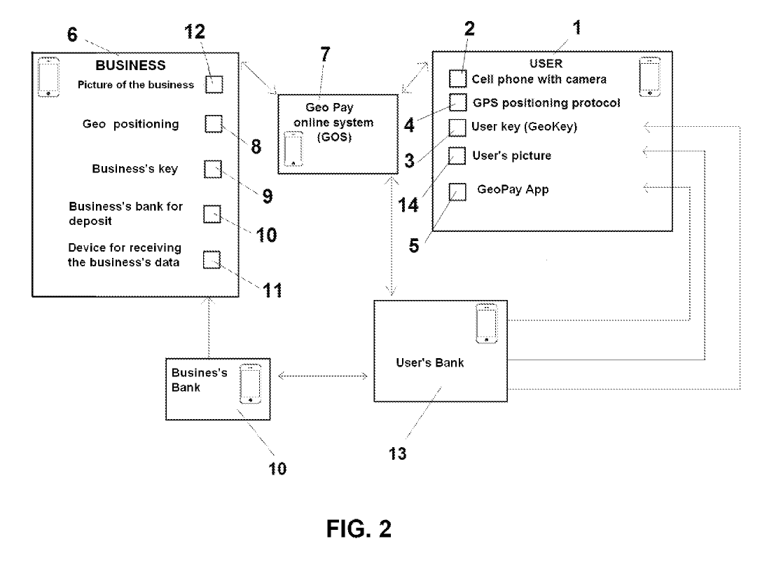

A diagrammatic scheme of the flows referring to the transactions between the parties.

1.—user,

2.—user cell phone,

3.—user key (GeoKey),

4.—positioning by GPS positioning protocol,

5.—GeoPay App,

6.—the business,

7.—GeoPay online system (GOS),

8.—geo-positioning of the business,

9.—the business's key,

10.—the business's bank for deposit,

11.—device for receiving the business's data,

12.—picture of the business,

13.—user's bank,

14.—user's picture

### A PREFERENTIAL EMBODIMENT OF THE INVENTION

The invention proposed refers to a payment process using a cell phone, by means of a photograph of the user and positioning GPS of both user and business, based on an application App called GeoPay, allowing an instantaneous payment transaction in any establishment with this system, very rapidly and securely.

The following are the elements involved in such transactions:
a user (1) with:
a cell phone with a photographic camera (2),
a user geokey (3) (needed the first time a business is authorised for payment),
a photograph of the user (14)
positioning by a GPS positioning protocol (4),
the GeoPay App (5) downloaded and with the collecting Bank, including the IBAN,
the business (6) selling the product or service, and authorised by “GeoPay online system” (GOS) (7), which downloads the “GeoPay App”, after sending its main data, i.e.:
Photo of the business (12),
Geo-positioning (8),
The business's key (9),
Bank for payment, with the IBAN (10),
Device for reception of the details of the business (11),

The business (6) also has a device (11) where it receives confirmation of payment along with the user's photograph (14) from the “GeoPay online system” (7) the electronic centre for the whole GeoPay system, to confirm the user's authenticity.
bank (13), issuer of the “GeoPay App” (5) for users, but which can also issue for businesses and which is the means whereby the amount for the transaction goes from the user's account to that of the business's bank (10) once the entire operation has been validated.
“GeoPay online system” (7) the electronic centre of the whole GeoPay system, validating not just all transactions between the system's users but also putting the user's bank (13) in contact with the account in the business's bank (10) to complete the financial transaction.

It also detects intrusion, attacks on the system and makes contact between users, business and banks, to extend payment possibilities to more users and businesses.

The process begins with issue by the bank of an App called “GeoPay” (5).

The user downloads the “GeoPay App” (5) sent to it by its bank (13) and sends it a photo of the user (14).

The bank (13) asks them for a user key (GeoKey) (3) and authorisation to charge payments generated using this procedure in the user's account.

The business (6) interested in being able to use this new means of payment asks to do so at “GeoPay online System” (GOS) (7) or an authorised bank.

If accepted, this request allows it to download the “GeoPay App” (5) after delivery of the data mentioned above, and including the type of business (9).

The procedure operates as follows:

A user admitted to GeoPay by issue of the GeoPay App (5) by their bank, with their associated GeoKey (3) (flow “A”) must authorise businesses (6) that accept GeoPay in advance (flow “B”).

Once actually in the business premises (6) or accessing the list of establishments belonging to the “GeoPay” system, they must authorise payments with their mobile using the GeoKey (3), (flow “B”).

Once the establishment is admitted, purchase can be done using “GeoPay”.

Thus, when wishing to pay, they must run the GeoPay App (5) on their mobile screen (2) where they will see the establishment concerned (or if a mall with several, selecting the one where they wish to pay) (flow “C”), indicating the amount of the transaction for payment, and the GOS system (7) will use the frontal camera to see if the person paying was admitted previously from the device (flow “D”).

If the device does not at that moment have the location set up, GOS (7) will immediately send a message to set it up, beginning the operation again.

“GeoPay Online System” (GOS) (7) receives this user information and verifies all the data of both user and establishment (flow “D” and “C”), i.e. that the user is who they say they are and that user and establishment are within the real distance parameters.

With these parameters confirmed, “GOS” (7) asks the user's bank (13) to authorise the payment (flow “I”)

If the response is positive, the bank replies to GOS (7) that the payment is authorised (flow “J”).

With this response “GOS” (7) informs the user (1) that the transaction has been authorised (flow “K1”).

At that point (GOS) (7) also sends the business (6) an electronic message with the authorisation, and with the user's photo (14) attached (flow K2”).

Then, if the bank (13) has authorised the transaction, GOS (7) delivers two messages:

The first to the user (1), stating that the transaction has taken place (flow “L”).

The second to the business (6), informing it that the transaction has been authorised by all parties and that the user's bank (13) has already received the order to transfer the sum concerned to the business's bank account (10) (flow “M”).

There may be a third message, to the business's bank (10), advising it that a sum will come from the user's bank (13) to the business's account for this transaction (flow “O”).

The business's bank (10) may inform the business (6) of notification of delivery of the user's (1) payment received from the user's bank (13) (flow “P”).

This complex operation in fact lasts just a few seconds thanks to the interrelation of the data bases involved and which are supported in powerful cloud-located data-base systems.

This is the simplest operational part but, with this operational base, it is possible to resolve the entire functioning of relations and incidents between the parties, such as products sent back, claim for errors, duplicated payments etc.

Having sufficiently described the nature of the invention and its practical implementation, it must be recorded that the specifications indicated above and represented in the attached drawings may be modified in detail provided that this does not alter their main principles established in the previous paragraphs and summarised in the following claims.

1. A PROCESS FOR PAYMENT BY CELL PHONE BY PICTURE AND GPS LOCATION for purchases by users in businesses, based on an Application called GeoPay installed in the user's cell-phone and making it possible complete a payment transaction almost instantaneously in any establishment with this system, and characterised because the elements involved in this transaction are at least as follows:
user (1) with:
cell phone fitted with a photographic camera (2),
user Geokey (3
user photo (14)
positioning by GPS positioning protocol (4),
GeoPay App (5) downloaded, with the collecting Bank and including the IBAN,
business (6) selling the product or service, and authorised by “GeoPay online system” (GOS) (7), which downloads the “GeoPay App”, after sending the following main data required:
Photo of the business (12),
Geo-positioning (8),
Business Key (9),
Payment bank with IBAN (10),
Device for reception of the business data (11).
bank (13) issuing the “GeoPay App” (5) for users (1) and businesses (6).
“GeoPay online system” (7), the whole GeoPay system's electronic centre which does not just validate all transactions between the system's users but also puts the user's bank (13) in contact with the account in the business's bank (10) to complete the financial transaction.
It also detects intrusions, attacks on the system and puts users, the business and banks in contact, to enlarge payment possibilities to more users and businesses.

2. A PROCESS FOR PAYMENT BY CELL PHONE BY PICTURE AND GPS LOCATION for purchases by users in businesses, based on an Application called GeoPay installed in the user's cell-phone making it possible to complete a payment transaction almost instantaneously in any establishment that has this system, as set for in claim 1, and characterised because the process for use of the system begins with issue by the bank (13) of an App called “GeoPay” (5).
The user downloads the “GeoPay App” (5) sent to them by their bank (13) and sends it a photo of the user (14).
The bank (13) asks them for a user key (GeoKey) (3) and authorisation to charge payments generated by this procedure in the user's account.
A business (6) interested in using this new payment procedure applies to “GeoPay online System” (GOS) (7) or an authorised bank to use it.
If accepted, this request allows it to download the “GeoPay App” (5) after delivery of the necessary data, including the type of business (9).

3. A PROCESS FOR PAYMENT BY CELL PHONE BY PICTURE AND GPS LOCATION for purchases by users in businesses, based on an Application called GeoPay installed in the user's cell-phone, making it possible to complete a payment transaction almost instantaneously in any establishment with this system, as set forth in the previous claims and characterised because the procedure operates as follows:
The user (1), admitted to GeoPay with the issue by its bank of the GeoPay App (5) and its associated GeoKey (3) (flow “A”), must authorise the businesses (6) that accept GeoPay previously (flow “B”).
Once actually in the business (6) or with access to the list of establishments forming part of the “GeoPay” system, they must authorise payments with their mobile using the GeoKey (3), (flow “B”).

4. A PROCESS FOR PAYMENT BY CELL PHONE BY PICTURE AND GPS LOCATION, for purchases by users in businesses, based on an Application called GeoPay installed in the user's cell-phone, making it possible to complete a payment transaction almost instantaneously in any establishment with this system, as set forth in the previous claims and characterised because, to pay for a purchase, the user (1) must open the GeoPay App (5) on their mobile screen (2) where the establishment will appear where they want to pay (flow “C”), indicating the amount of the transaction to pay, and the GOS system (7) will use the frontal camera to analyse whether the party paying is the one that was previously admitted via that device (flow “D”).
The “GeoPay Online System” (GOS) (7) receives this information from the user and verifies all the data, of both user and establishment (flow “D” and “C) and, with these parameters verified, “GOS” (7) asks the user's bank (13) to authorise payment (flow “I”).

5. A PROCESS FOR PAYMENT BY CELL PHONE BY PICTURE AND GPS LOCATION for purchases by users in businesses, based on an Application called GeoPay installed in the user's cell-phone, making it possible to complete a payment transaction almost instantaneously in any establishment with this system, as set forth in claim 4 and characterised because if the response to authorisation for payment is positive the bank replies to GOS (7) that the payment is authorised (flow “J”), and “GOS” (7) informs the user that the transaction has been authorised (flow “K1”), at that point also sending the business (6) an electronic message with the authorisation, and to which the photo of the user (14) is attached, (flow K2”).

6. A PROCESS FOR PAYMENT BY CELL PHONE BY PICTURE AND GPS LOCATION, for purchases by users in businesses, based on an Application called GeoPay installed in the user's cell-phone, making it possible to complete a payment transaction almost instantaneously in any establishment with this system, as set forth in claims 4 and 5 and characterised because, if the (13) has authorised the transaction, GOS (7) sends two messages:
The first to the user (1), indicating that the transaction has taken place (flow “L”).
The second to the business (6) advising it that the transaction has been authorised by all parties and that the user's bank (13) already has the order to transfer the sum mentioned into the business's bank account (10) (flow “M”).

7. A PROCESS FOR PAYMENT BY CELL PHONE BY PICTURE AND GPS LOCATION for purchases by users in businesses, based on an Application called GeoPay installed in the user's cell-phone, making it possible to complete a payment transaction almost instantaneously in any establishment with this system, as set forth in claims 4, 5 and 6, characterised because there may be a third message, to the business's bank (10), advising it that a sum will come to it at the business's account from user's bank (13) for this transaction (flow “O”).

8. A PROCESS FOR PAYMENT BY CELL PHONE BY PICTURE AND GPS LOCATION for purchases by users in businesses, based on an Application called GeoPay installed in the user's cell-phone, making it possible to complete a payment transaction almost instantaneously in any establishment with this system, as set forth in the previous claims and characterised because the business's bank (10) can inform the business (6) of notification of delivery of the user's payment (1) received from the user's bank (13) (flow “P”).
